(19) United States
(12) Patent Application Publication
(10) Pub. No.: US 2008/0145614 A1
(43) Pub. Date: Jun. 19, 2008

(54) Apparatus and method of protecting a sheet of glass

(75) Inventor: Gary E. Meyers, Englewood, CO (US)

Correspondence Address: LAW OFFICE OF DALE B. HALLING, LLC, 655 SOUTHPOINTE CT, SUITE 100, COLORADO SPRINGS, CO, 80906, US

(73) Assignee: Clear Applications, Inc.

(21) Appl. No.: 11/640,580

(22) Filed: Dec. 18, 2006

(51) Int. Cl. B32B 7/02; B05D 5/06; B05D 3/06; B32B 17/06

(52) U.S. Cl. 428/152; 427/164; 427/558; 427/160; 428/426

(57) ABSTRACT

A method of protecting a sheet of glass has a clear sheet of plastic that is adhered to a surface of the sheet of glass. A coating is applied over the clear sheet of plastic. The adhesive, plastic and coating are all resistant to UV light, which means that they will stay clear even after an extended exposure to sunlight. The plastic is a hard piece of plastic that is resistant to chipping and abrasions. The coating over the plastic is even harder than the plastic. The coating further protects the plastic from chipping and abrasions. The adhesive is releasable so that the protective layer of plastic may be removed as it becomes scratched, pitted and chipped.

### RELATED APPLICATIONS

None

### FIELD OF THE INVENTION

The present invention relates generally to the field of glass and more particularly to a method of protecting a sheet of glass.

### BACKGROUND OF THE INVENTION

Sheets of glass whether compound curved or flat, such as automobile windshields, are fragile, subject to chips, scratches and pitting. Replacing a sheet of glass or windshield is expensive and time consuming. One solution is to use extremely thick sheets of glass that are much more difficult to break. However, these sheets of glass are heavy and are still subject to chips, pitting and scratches from sand rocks and other road-borne aggregate. Because of the weight of a thick sheet of glass, this is not an acceptable solution for increasing the durability of windshields. Another solution for windshields has been to provide a protective plastic layer around the outer edge of the windshield. According to the providers of this solution, most windshields purportedly break because of impacts around the edge of the windshield where the glass is subject to the windshield hold down trim stress and less durable. However, this solution still does nothing to prevent chipping, scratches and pitting over all of the windshield. In addition, the plastic layer on the outer edge of the windshield became opaque over time.

Thus there exists a need for a method of protection a sheet of flat and compound glass.

### SUMMARY OF INVENTION

A method of protecting a sheet of glass that overcomes these and other problems has an optically clear sheet of plastic that is adhered to a surface of a sheet of glass. A hard coating is applied over the clear sheet of plastic, on the atmospheric side. The adhesive, plastic and coating are all resistant to UV light, which means that they will stay clear even after an extended exposure to sunlight. The plastic is a hard piece of plastic that is resistant to chipping and abrasions. The hard coating over the plastic is significantly harder than the plastic. The coating further protects the plastic from chipping and abrasions. The adhesive is releasable so that the protective layer of plastic may be removed when it becomes chipped, pitted, and scratched. The plastic and hard coating provides a significant protective barrier for the glass. This is particularly important in the case of automobile windshields. Companies with large fleets of trucks and cars spend millions of dollars every year replacing windshields. This invention significantly increases the useful life of a windshield.

### BRIEF DESCRIPTION OF THE DRAWINGSIC?

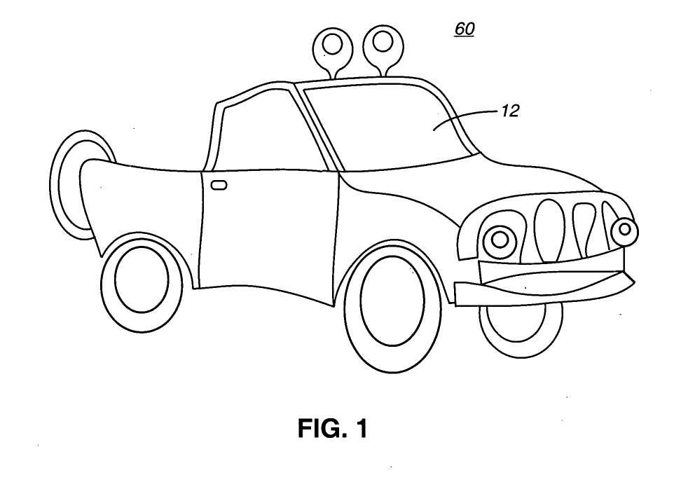

FIG. 1 is a perspective view of a vehicle that can use the glass laminate as a windshield in accordance with one embodiment of the invention;

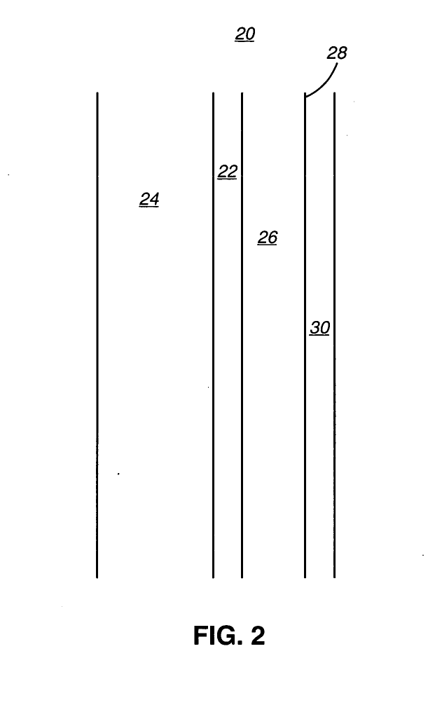

FIG. 2 is a cross sectional view of a glass laminate in accordance with one embodiment of the invention; and

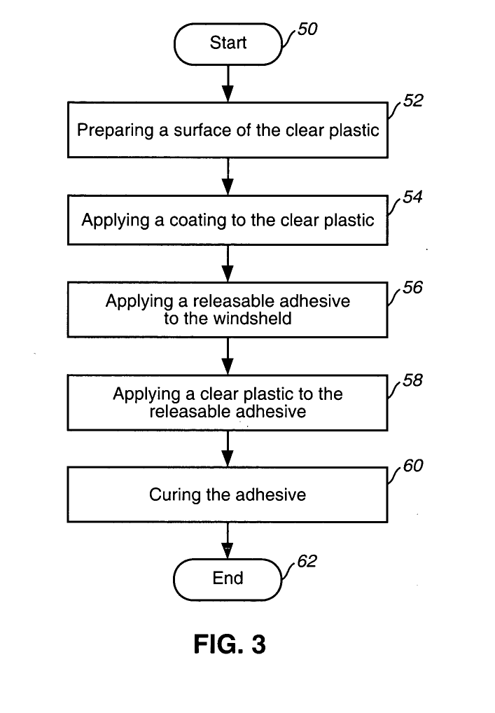

FIG. 3 is a flow chart of the steps used in a method of protecting a glass sheet in accordance with one embodiment of the invention.

### DETAILED DESCRIPTION OF THE DRAWINGS

The present invention is directed to a method of protecting a sheet of glass that has a clear sheet of plastic that is adhered to a surface of a sheet of glass. A coating is applied over the clear sheet of plastic. The adhesive, plastic and coating are all resistant to UV light, which means that they will stay clear even after extended exposure to sunlight. The plastic is a hard piece of plastic that is resistant to chipping and abrasions. The coating over the plastic is even harder than the plastic. The coating further protects the plastic from chipping and abrasions. The adhesive is releasable so that the protective layer of plastic may be removed if it becomes scratched. The plastic and coating provide a significant protective barrier for the glass. This is particularly important in the case of automobile windshields. Companies with large fleets of trucks and cars spend millions of dollars every year replacing windshields. This invention significantly increases the useful life of a windshield.

FIG. 1 is a perspective view of a vehicle that can use the a glass laminate as a windshield in accordance with one embodiment of the invention. This figure shows a truck 10 that has a windshield 12. The windshield 12 is vulnerable to scratches and chipping by rocks and other foreign objects impacting the windshield 12. By protecting the windshield 12 as described herein the life of the existing windshield 12 can be increased.

FIG. 2 is a cross sectional view of a glass laminate 20 in accordance with one embodiment of the invention. An adhesive 22 is applied to a sheet of glass 24. The sheet of glass 24 can be any ordinary sheet of glass, however the invention is particularly useful and cost effective for windshields of vehicles. The adhesive 22 is optically clear and Ultra-Violet (UV) light resistant. UV resistant means that the adhesive 22 will not yellow or become opaque when exposed to intense sunlight for an extended period of time. A clear rigid plastic 26 is adhered to the glass 24 by the adhesive 22. In one embodiment, the clear rigid plastic 26 is acrylic. The sheet of acrylic material 26 is cleaned with isopropyl alcohol before being applied to the adhesive in one embodiment. The acrylic panel 26 is pressed against the glass 24 to spread the adhesive 22 in order to cover the entire bonding area. In one embodiment, the adhesive is “DYMAX Ultra Light Weld® 3099 Series” adhesive available from DYMAX corporation 51 Greenwoods road, Torrington, Conn. 06790. Once the acrylic panel 26 is pressed against the adhesive 22 the adhesive is cured by applying high intensity visible and/or UV light. In one embodiment, the high intensity light is provided by a “5000-EC” lamp available from DYMAX. The high intensity light is applied for 20 seconds in one embodiment.

The exposed surface 28 of the acrylic panel 26 is then cleaned with hexane and isopropanol. Next, the exposed surface 28 is blown with ionized nitrogen. The coating 30 is then applied to the acrylic panel 26. The coating 30 is optically clear and is UV resistant, abrasion resistant and resistant to attacks by common chemicals. In addition, the clear coating is harder than the acrylic plastic panel 26. The coating 30 may be applied in a temperature and humidity controlled Class 100 environment. The coating is then dried under ambient conditions for 30 minutes and then cured in an oven at 82 degrees centigrade for four hours. In one embodiment, the coating is “CrystalCoat™ MP 100 or MP 124” from SDC Technologies, 1911 Wright Circle, Anaheim, Calif. 92806. The MP 100 adhesive is a polysiloxane based thermal cure coating. Note that while acrylic is the presently preferred plastic material, polycarbonate, polyurethane and other rigid, optically clear plastics may be used.

In the case of a windshield, which is not generally a flat piece of glass, the plastic sheet has to be formed and cut into the same shape as the windshield. Generally, the plastic will completely cover the windshield, however there may be applications where only part of the windshield is covered. If the coating/plastic become scratched or chipped the adhesive is releasable. In one embodiment, the adhesive is released by applying high temperatures that the windshield would not encounter during operation of the vehicle. The old plastic/coating is then removed and a new plastic/coating is applied to protect the windshield.

FIG. 3 is a flow chart of the steps used in a method of protecting a glass sheet in accordance with one embodiment of the invention. The process starts, step 50, a surface of a clear plastic is prepared at step 52. Next, a coating is applied to the clear plastic at step 54. A releasable adhesive is applied to the windshield to the plastic at step 56. The clear plastic is applied to the releasable adhesive at step 58. At step 60, the adhesive is cured, which ends the process at step 62. Note that in the embodiment, the plastic is first shaped by thermoforming, or vacuum formed to produce a conformable shape that matches the convex shape of the windshield. In another embodiment, the adhesive is applied to the plastic at step 56 instead of to the windshield. Either way the adhesive bonds the windshield to the plastic. Note that the plastic is manually pressed onto the windshield. Commonly, a machine is need to press a plastic adhered to glass to obtain an optically clear combination. However, the present invention accomplishes this without the need for high pressures that require a machine.

Thus there has been described a method of protection a sheet of glass that is particularly useful in protecting windshields of vehicles. Windshields protected by this method last significantly longer than unprotected windshields.

While the invention has been described in conjunction with specific embodiments thereof, it is evident that many alterations, modifications, and variations will be apparent to those skilled in the art in light of the foregoing description. Accordingly, it is intended to embrace all such alterations, modifications, and variations in the appended claims.

What is claimed is:

1. A method of protecting a windshield, comprising the steps of:
a) applying a coating to a clear plastic; and
b) applying a releasable adhesive to bond the windshield to the clear plastic.

2. The method of claim 1, wherein step (a) further includes the step of sizing a piece of acrylic plastic.

3. The method of claim 1, further including the step of exposing the adhesive to a ultra-violet light.

4. The system of claim 1, wherein step (b) further includes the step of cleaning a surface of the clear plastic with hexane.

5. The system of claim 4, further including the step of cleaning the surface of the clear plastic with isopropanol.

6. The system of claim 5, further including the step of blowing the clear plastic with ionized nitrogen.

7. The system of claim 1, wherein the releasable adhesive remains optically clear after extended exposure to sunlight.

8. A method of protecting a sheet of glass, comprising the steps of:
a) applying an adhesive to the sheet of glass, wherein the adhesive remains optically clear after extended exposure to sunlight; and
b) applying a UV resistant plastic to the adhesive.

9. The method of claim 8, further including the step of:
c) applying a coating over the UV resistant plastic.

10. The method of claim 9, wherein the step (b) further includes the step of selecting a rigid plastic.

11. The method of claim 8, wherein step (a) further includes the step of selecting an adhesive that is UV resistant.

12. The method of claim 11, further includes the step of selecting an adhesive that is releasable.

13. The method of claim 9, wherein step (c) further includes the step of selecting a coating that is resistant to chemical attack.

14. A glass laminate, comprising:
a sheet of glass;
a clear plastic releasably adhered to the sheet of glass; and
a clear coating covering the clear plastic.

15. The glass laminate of claim 14, wherein the clear plastic is UV resistant.

16. The glass laminate of claim 15, wherein the clear plastic is rigid.

17. The glass laminate of claim 14, wherein an adhesive used to adhere the clear plastic is UV resistant.

18. The glass laminate of claim 14, wherein the clear coating is chemical resistant.

19. The glass laminate of claim 18, wherein the clear coating is abrasion resistant.
